(19) United States
(12) Patent Application Publication
(10) Pub. No.: US 2026/0133351 A1
(43) Pub. Date: May 14, 2026

(54) PHOTOGRAPHIC FILTER ASSEMBLY

(71) Applicant: Zhongshan City Xingsheng Optical Co., Ltd., Zhongshan (CN)

(72) Inventors: Mingzheng YANG, Zhongshan (CN); Yuting LIN, Zhongshan (CN); Yong ZHANG, Zhongshan (CN)

(73) Assignee: Zhongshan City Xingsheng Optical Co., Ltd., Zhongshan (CN)

(21) Appl. No.: 19/002,475

(22) Filed: Dec. 26, 2024

(30) Foreign Application Priority Data
Nov. 8, 2024 (CN) 2024227381716

(51) Int. Cl. G02B 5/02; G03B 11/00

(52) U.S. Cl. CPC G02B 5/0242; G02B 5/0294; G03B 11/00

(57) ABSTRACT

The present invention discloses a photographic filter assembly. The photographic filter assembly includes a first optical glass and a second optical glass, where the first optical glass is glued with a basic filter, the second optical glass is coated with a diffusion glue layer, diffusion particles are evenly distributed in the diffusion glue layer, and the diffusion glue layer is bonded to the basic filter.

### CROSS-REFERENCE TO RELATED APPLICATIONS

The application claims priority to Chinese patent application No. 2024227381716, filed on Nov. 8, 2024, the entire contents of which are incorporated herein by reference.

### TECHNICAL FIELD

The present invention relates to the technical field of filters, and in particular to a photographic filter assembly.

### BACKGROUND

Due to the presence of COMS sensors, photos taken by existing digital photography have obvious digital graininess and lack the fineness and smoothness of traditional films. Therefore, such photos need to be diffused by a circular polarizer (CPL) filter/variable neutral density (VND) filter plus a diffusion filter. The CPL filter is superimposed on the diffusion filter, and the VND component composed of two CPLs is superimposed on the diffusion filter. The two filters are installed in two filter frames respectively and are superimposed by threading or magnetic absorption. However, the superposition of multiple filters will affect the image quality, and the specific effects are as follows: 1. residual reflections on the surfaces of multiple filters are superimposed on each other, which leads to the appearance of halations during photographing; 2. the filters are too large in number, and are thus inconvenient to carry; 3. the superposition of multiple filters makes the lens too long and the angle of view limited, which further causes the phenomenon of underexposed shadows at the periphery of the picture.

### SUMMARY

An objective of the present invention is to at least solve one of the technical problems existing in the prior art and to provide a photographic filter assembly that can reduce multiple halations and lower vignetting in photography.

The photographic filter assembly according to the present invention includes a first optical glass and a second optical glass, where the first optical glass is glued with a basic filter, the second optical glass is coated with a diffusion glue layer, diffusion particles are evenly distributed in the diffusion glue layer, and the diffusion glue layer is bonded to the basic filter.

The photographic filter assembly according to the present invention at least has the following beneficial effects: by putting a basic filter and a diffusion coating between two optical glasses, the extinction and diffusion effects of two filters (basic filter+diffusion filter) can be satisfied at the same time by using only one basic filter. The shooting effects of the basic filter and the diffusion filter are combined, which reduces the photographer's work of disassembling and assembling a filter, making it easy to use and carry; the number of filters is significantly reduced, which not only reduces the multiple halations originally generated by multiple filters to make the image quality clearer and more transparent, but also reduces the overall thickness of the filter assembly to increase the field of view, and reduce the occurrence of vignetting in photography; in addition, multiple filters turn into a single component, thereby reducing the production cost.

The additional aspects and advantages of the present invention will be partially presented in the following description, some of which will become apparent from the following description, or learned through practice of the present invention.

### BRIEF DESCRIPTION OF THE DRAWINGS

The specific embodiments of the present invention are further illustrated below in conjunction with the accompanying drawings;

FIG. 1 is a sectional diagram of a photographic filter assembly;

FIG. 2 is an exploded structural diagram of a photographic filter assembly;

FIG. 3 is a shooting effect diagram without a filter;

FIG. 4 is a ⅛-level white diffusion effect diagram;

FIG. 5 is a ¼-level white diffusion effect diagram;

FIG. 6 is a ½-level white diffusion effect diagram;

FIG. 7 is a 1-level white diffusion effect diagram;

FIG. 8 is a ⅛-level black diffusion effect diagram;

FIG. 9 is a ¼-level black diffusion effect diagram;

FIG. 10 is a ½-level black diffusion effect diagram; and

FIG. 11 is a 1-level black diffusion effect diagram.

### DETAILED DESCRIPTION OF THE EMBODIMENTS

This part will describe the specific embodiments of the present invention in detail. The preferred embodiments of the present invention are shown in the accompanying drawings, and the function of the drawings is to supplement the description of the text part of the specification with graphics, which enables people to intuitively and vividly understand each technical feature and the overall technical solutions of the present invention, but cannot be understood as limitations to the scope of protection of the present invention.

In the description of the present invention, it should be understood that the positional descriptions referred to, for example, the directional or positional relationships indicated by up, down, front, rear, left, right, etc., are based on the directional or positional relationships shown in the drawings, and are only for convenience and simplification of description of the present invention, but not for indicating or implying that the referred device or element must have a specific direction, be constructed and operated in a specific direction, and thus should not be construed as limiting the present invention.

In the description of the present invention, “several” means one or more, “a plurality of” means more than two, “greater than a number”, “less than a number”, “exceed a number” and the like indicate that the number is excluded, and “above a number”, “below a number”, “within a number”, and the like indicate that the number is included. “First” and “second” are intended only for distinguishing between technical features but cannot be used to indicate or imply relative importance or implicitly specify a quantity of indicated technical features or implicitly specify a sequential relationship of indicated technical features.

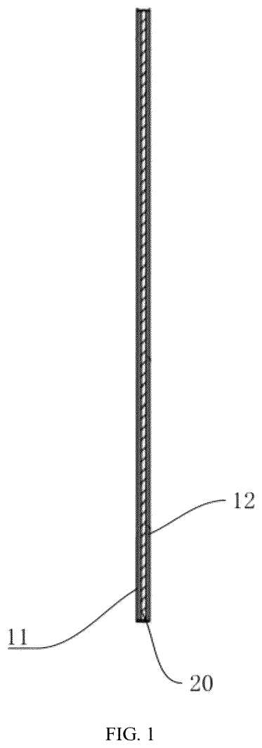

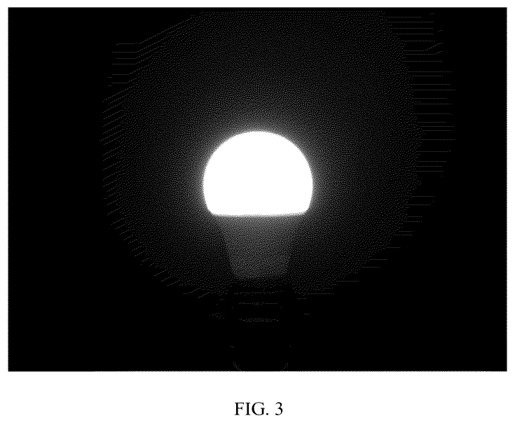

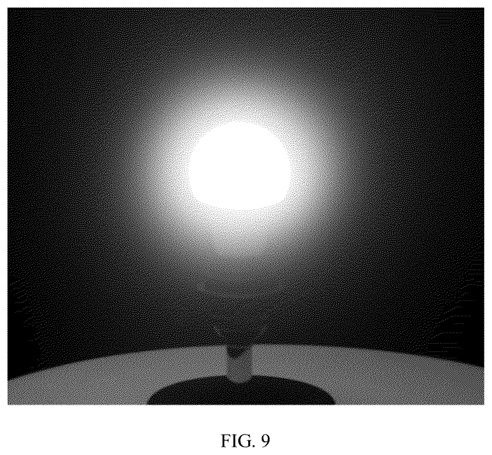

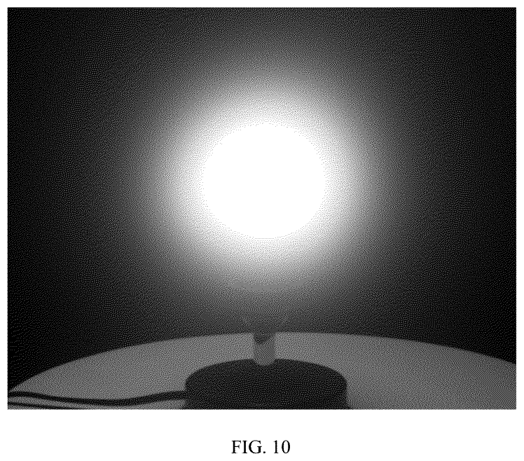

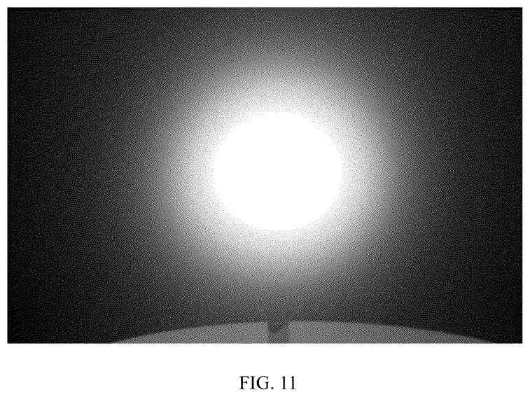

Referring to FIG. 1 to FIG. 11, the photographic filter assembly according to the present invention includes a first optical glass 11 and a second optical glass 12, where the first optical glass 11 is glued with a basic filter 20, the second optical glass 12 is coated with a diffusion glue layer 30, diffusion particles are evenly distributed in the diffusion glue layer 30, and the diffusion glue layer 30 is bonded to the basic filter 20. By putting the basic filter 20 and a diffusion coating between two optical glasses, the extinction and diffusion effects of two filters (basic filter 20+diffusion filter) can be satisfied at the same time by using only one basic filter 20. The shooting effects of the basic filter 20 and the diffusion filter are combined, which reduces the photographer's work of disassembling and assembling a filter, making it easy to use and carry; the number of filters is significantly reduced, which not only reduces the multiple halations originally generated by multiple filters to make the image quality clearer and more transparent, but also reduces the overall thickness of the filter assembly to increase the field of view, and reduce the occurrence of vignetting in photography; in addition, multiple filters turn into a single component, thereby reducing the production cost.

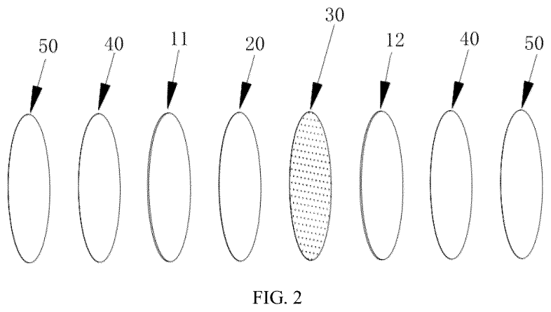

As shown in FIG. 2, the filter assembly further includes an anti-reflection membrane 40 and a waterproof membrane 50, where the anti-reflection membrane 40 is disposed on an outer surface of the first optical glass 11 and an outer surface of the second optical glass 12, and the waterproof membrane 50 is disposed on the anti-reflection membrane 40, thereby achieving the effects of anti-reflection and water proofing.

The basic filter 20 includes a CPL filter, a VND filter or an ND filter. For the CPL filter assembly, firstly, the optical glass is processed by polishing the surface of the optical glass; then a CPL is glued to the first optical glass 11; the surface of the second optical glass 12 is coated with a diffusion glue layer 30; then the two optical glasses are bonded together, and the surface with the CPL and the diffusion glue layer 30 are bonded to each other; then the gluing layer is defoamed, and is cured; and finally vacuum coating is carried out. That is, a CPL and a diffusion coating are both put between two optical glasses, so that the extinction and diffusion effects of two filters can be satisfied at the same time by using only one filter.

For the VND filter assembly, the VND filter includes two CPLs, where one CPL is glued to the first optical glass 11; the surface of the second optical glass 12 is coated with a diffusion glue layer 30; then two optical glasses are bonded together, and the surface of the other CPL and the diffusion glue layer 30 are bonded to each other. That is, one of the CPLs is bonded with the diffusion glue layer 30 to form a diffusion VND. While the level adjustability of the traditional VND is kept, a diffusion effect on pictures taken is achieved, so that the needs of most shooting scenarios are met.

This structure and process can also be extended and applied to filters of other types. For example, by adding a diffusion glue layer 30 between the ND filter and the optical glass, an ND diffusion filter can be made; by adding a diffusion glue layer 30 to a star filter, a star diffusion filter can be made. In this way, diffusion filters of different types can be made according to needs, so that the needs of various usage scenarios can be met.

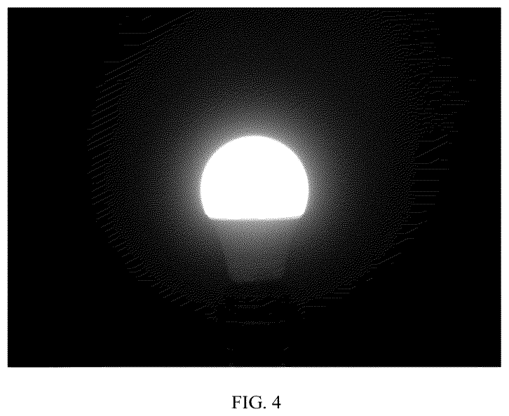

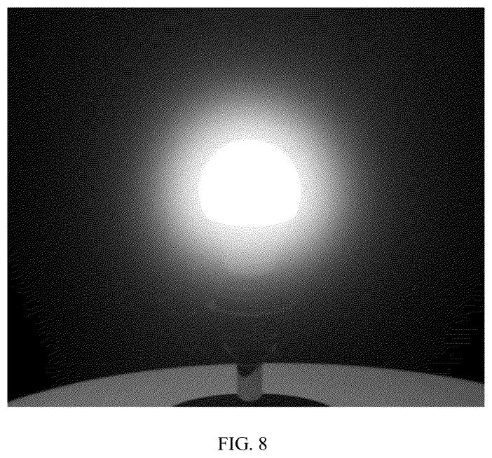

Preferably, the diffusion glue layer 30 refers to diffusion particles with a diameter of φ0.01 mm to φ0.05 mm mixed in photosensitive glue. The diffusion particles include, but are not limited to, carbon powder particles (the main component is carbon), quartz particles (the main component is SiO₂) and other particles (such as PMMA, polypropylene and other polymer materials). The particles are evenly distributed in the coating, and diffusion effects of different specifications are produced by using particles with different diameters, which corresponds to diffusion filters of different specifications and levels. When the particles are black particles made of materials such as carbon powder, a black diffusion filter can be made; when the particles are white particles made of materials such as quartz or a high polymer material, a white diffusion filter can be made; and diffusion materials of other colors can also be selected according to actual needs to make diffusion filters with different color specifications. FIG. 4 to FIG. 7 show a regular white diffusion filter, and FIG. 8 to FIG. 11 show a regular black diffusion filter.

As shown in FIG. 4, in case the diffusion particles have a diameter of φ0.01 mm to φ0.02 mm, a ⅛-level diffusion effect is modulated correspondingly.

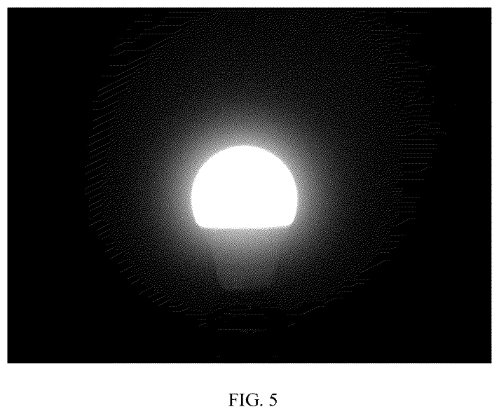

As shown in FIG. 5, in case the diffusion particles have a diameter of φ0.02 mm to 0.03 mm, a ¼-level diffusion effect is modulated correspondingly.

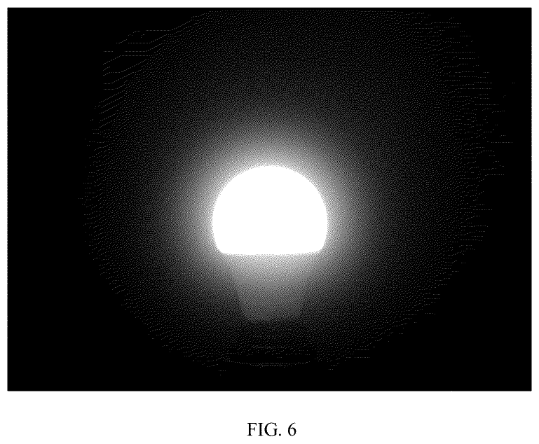

As shown in FIG. 6, in case the diffusion particles have a diameter of φ0.03 mm to φ0.04 mm, a ½-level diffusion effect is modulated correspondingly.

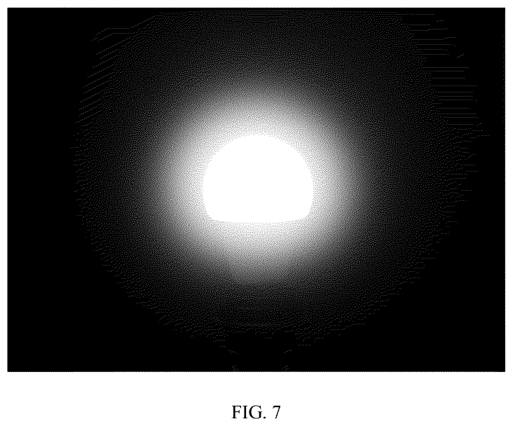

As shown in FIG. 7, when the diffusion particles have a diameter of φ0.04 mm to φ0.05 mm, a 1-level diffusion effect is achieved correspondingly.

Those skilled in the art can easily understand that on the premise of non-conflict, the above preferred embodiments can be freely combined and mixed.

The above descriptions are only preferential embodiments of the present invention, but are not intended to limit the patent scope of the present invention. Any equivalent structural variation made by using the specification and the accompanying drawings of the present invention, or directly or indirectly applied to other related technical fields under the invention concept of the present invention shall fall within the patent protection scope of the present invention.

What is claimed is:

1. A photographic filter assembly, comprising:
a first optical glass (11) and a second optical glass (12), wherein the first optical glass (11) is glued with a basic filter (20), the second optical glass (12) is coated with a diffusion glue layer (30), diffusion particles are evenly distributed in the diffusion glue layer (30), and the diffusion glue layer (30) is bonded to the basic filter (20).

2. The photographic filter assembly according to claim 1, wherein the basic filter (20) comprises a circular polarizer (CPL) filter, a variable neutral density (VND) filter or a neutral density (ND) filter.

3. The photographic filter assembly according to claim 1, wherein the diffusion particles have a diameter of φ0.01 mm to φ0.05 mm.

4. The photographic filter assembly according to claim 3, wherein in case the diffusion particles have a diameter of φ0.01 mm to φ0.02 mm, a ⅛-level diffusion effect is achieved correspondingly.

5. The photographic filter assembly according to claim 3, wherein in case the diffusion particles have a diameter of φ0.02 mm to φ0.03 mm, a ¼-level diffusion effect is achieved correspondingly.

6. The photographic filter assembly according to claim 3, wherein in case the diffusion particles have a diameter of φ0.03 mm to φ0.04 mm, a ½-level diffusion effect is achieved correspondingly.

7. The photographic filter assembly according to claim 3, wherein in case the diffusion particles have a diameter of φ0.04 mm to φ0.05 mm, a 1-level diffusion effect is achieved correspondingly.

8. The photographic filter assembly according to claim 1, wherein a material of the diffusion particles comprises carbon powder, quartz, PMMA or polypropylene.

9. The photographic filter assembly according to claim 1, wherein anti-reflection membranes (40) are respectively disposed on an outer surface of the first optical glass (11) and an outer surface of the second optical glass (12).

10. The photographic filter assembly according to claim 9, wherein a waterproof membrane (50) is disposed on the anti-reflection membrane (40).
